(19) United States
(12) Patent Application Publication
(10) Pub. No.: US 2024/0255673 A1
(43) Pub. Date: Aug. 1, 2024

(54) SYSTEMS AND METHODS FOR DETECTING FRACTURE-DRIVEN INTERACTIONS AND IDENTIFYING FRACTURE-DRIVEN INTERACTION RISK IN A SUBSURFACE VOLUME OF INTEREST

(71) Applicant: CHEVRON U.S.A. INC., San Ramon, CA (US)

(72) Inventors: Alena Grechishnikova, Midland, TX (US); Shane James Prochnow, Fredericksburg, TX (US); Paymon Pourmoradi Hossaini, Cypress, TX (US); Anahita Pourjabbar, Houston, TX (US)

(21) Appl. No.: 18/104,087

(22) Filed: Jan. 31, 2023

(51) Int. Cl. G01V 99/00

(52) U.S. Cl. CPC G01V 20/00

(57) ABSTRACT

Methods, systems, and non-transitory computer readable media for detecting fracture-driven interactions in a subsurface volume of interest and identifying fracture-driven interaction risk in a subsurface volume of interest are disclosed. Exemplary implementations may include: obtaining wellbore production data, generating a trend, generating threshold parameters, generating fracture-driven interaction candidate data, identifying an active child well, identifying potentially interactive wellbore production data, detecting the fracture-driven interaction event, obtaining target fracture-driven interaction event data, obtaining a conditioned fracture-driven interaction model, and generating target fracture-driven interaction event probability data.

### FIELD OF THE DISCLOSURE

The present disclosure relates to systems and methods for detecting fracture-driven interactions and identifying fracture-driven interaction risk in a subsurface volume of interest.

### SUMMARY

Implementations of the disclosure are directed to systems and methods for detecting fracture-driven interactions and identifying fracture-driven interaction risk in a subsurface volume of interest.

An aspect of the present disclosure relates to a computer-implemented method for detecting fracture-driven interactions and identifying fracture-driven interaction risk in a subsurface volume of interest. The method may be implemented in a computer system that includes a physical computer processor and non-transitory storage medium. The method may include a number of steps. One step may include obtaining wellbore production data corresponding to the subsurface volume of interest from the non-transitory storage medium. Another step may include generating a trend of the wellbore production data by applying a filter to the wellbore production data. Yet another step may include generating threshold parameters based on the wellbore production data. The threshold parameters may be used to set boundaries on the wellbore production data. Another step may include generating fracture-driven interaction candidate data for a parent well by applying the trend and the threshold parameters to the subsurface data. The fracture-driven interaction candidate data is a subset of the wellbore production data that exceed the ranges generated by the threshold parameters. Yet another step may include identifying an active child well in a threshold spatial region around the parent well corresponding to a coincident time of the fracture-driven interaction candidate data for the parent well. Another step may include identifying potentially interactive wellbore production data corresponding to the active child well during the coincident time. Yet another step may include detecting the fracture-driven interaction event based on the potentially interactive wellbore production data and the fracture-driven interaction candidate data.

In implementations, the computer system may further include a graphical user interface. One of the steps of the method may include generating a representation of the fracture-driven interactions as a function of position in the subsurface volume of interest using visual effects to depict at least a portion of the fracture-driven interaction event as a function of position in the subsurface volume of interest. Another step may include displaying the representation.

In implementations, the wellbore production data may include production data, completion data, and pressure data.

In implementations, the active child wells may be wells being operated on at the time of interest.

In implementations, the trend may be derived by convolving subsets of the wellbore production data.

In implementations, the threshold parameters may be derived from rolling standard deviations of the wellbore production data.

In implementations, the threshold spatial region may cover a 10 mile radius.

In implementations, the coincident time may cover a twenty-four hour period.

In implementations, the fracture-driven interaction event may indicate an effect the active child well has on the parent well.

An aspect of the present disclosure relates to a system for detecting fracture-driven interactions in a subsurface volume of interest. The system may include non-transitory storage medium. The system may also include a physical computer processor configured by machine readable instructions to perform a number of steps. One step may include obtaining wellbore production data corresponding to the subsurface volume of interest from the non-transitory storage medium. Another step may include generating a trend of the wellbore production data by applying a filter to the wellbore production data. Yet another step may include generating threshold parameters based on the wellbore production data. The threshold parameters may be used to set boundaries on the wellbore production data. Another step may include generating fracture-driven interaction candidate data for a parent well by applying the trend and the threshold parameters to the subsurface data. The fracture-driven interaction candidate data may be a subset of the wellbore production data that exceed the ranges generated by the threshold parameters. Yet another step may include identifying an active child well in a threshold spatial region around the parent well corresponding to a coincident time of the fracture-driven interaction candidate data for the parent well. Another step may include identifying potentially interactive wellbore production data corresponding to the active child well during the coincident time. Yet another step may include detecting the fracture-driven interaction event based on the potentially interactive wellbore production data and the fracture-driven interaction candidate data.

In implementations, another step of the method may include generating a representation of the fracture-driven interactions as a function of position in the subsurface volume of interest using visual effects to depict at least a portion of the fracture-driven interaction event as a function of position in the subsurface volume of interest. Yet another step may include displaying the representation.

In implementations, the wellbore production data may include production data, completion data, and pressure data.

In implementations, the trend may be derived by convolving subsets of the wellbore production data.

In implementations, the threshold parameters may be derived from rolling standard deviations of the wellbore production data.

In implementations, the threshold spatial region may cover a 10 mile radius, and wherein the coincident time covers a twenty-four hour period.

In implementations, the fracture-driven interaction event may indicate an effect the active child well has on the parent well.

An aspect of the present disclosure relates to a non-transitory computer-readable storage medium storing instruction for detecting fracture-driven interactions in a subsurface volume of interest. The instructions may be configured to, when executed, perform a number of steps. One step may include obtaining wellbore production data corresponding to the subsurface volume of interest from non-transitory storage medium. Another step may include generating a trend of the wellbore production data by applying a filter to the wellbore production data. Yet another step may include generating threshold parameters based on the wellbore production data, wherein the threshold parameters are used to set boundaries on the wellbore production data. Another step may include generating fracture-driven interaction candidate data for a parent well by applying the trend and the threshold parameters to the subsurface data. The fracture-driven interaction candidate data may be a subset of the wellbore production data that exceed the ranges generated by the threshold parameters. Yet another step may include identifying an active child well in a threshold spatial region around the parent well corresponding to a coincident time of the fracture-driven interaction candidate data for the parent well. Another step may include identifying potentially interactive wellbore production data corresponding to the active child well during the coincident time. Yet another step may include detecting the fracture-driven interaction event based on the potentially interactive wellbore production data and the fracture-driven interaction candidate data.

In implementations, another step may include generating a representation of the fracture-driven interactions as a function of position in the subsurface volume of interest using visual effects to depict at least a portion of the fracture-driven interaction event as a function of position in the subsurface volume of interest. Yet another step may include displaying the representation.

In implementations, the wellbore production data may include production data, completion data, and pressure data.

In implementations, the fracture-driven interaction event may indicate an effect the active child well has on the parent well.

An aspect of the present disclosure relates to a method for identifying fracture-driven interaction risk in a subsurface volume of interest. The method may be implemented in a computer system that includes a physical computer processor and non-transitory storage medium. The method may include a number of steps. One step may include obtaining an initial fracture-driven interaction model. The initial fracture-driven interaction model may include fracture-driven interaction parameters that affect the fracture-driven interactions in the subsurface volume of interest. Another step may include obtaining training fracture-driven interaction event data. Yet another step may include obtaining training fracture-driven interaction event probability data. Another step may include training the initial fracture-driven interaction model to generate a conditioned fracture-driven interaction model predicting fracture-driven interaction risk based on the training fracture-driven interaction event data and the fracture-driven interaction event probability data. The conditioned fracture-driven interaction model may include a subset of the fracture-driven interaction parameters that have a greater effect on the fracture-driven interactions in the subsurface volume of interest. Yet another step may include storing the conditioned fracture-driven interaction model.

In implementations, one step may include obtaining target fracture-driven interaction event data corresponding to the subsurface volume of interest. Another step may include generating target fracture-driven interaction event probability data by applying the conditioned fracture-driven interaction model to the target wellbore production data.

In implementations, the computer system may further include a graphical user interface. Another step in the method may include generating a representation of the fracture-driven interaction risk as a function of position in the subsurface volume of interest using visual effects to depict at least a portion of the fracture-driven interaction event probabilities as a function of position in the subsurface volume of interest. Yet another step may include displaying the representation.

In implementations, individual ones of the training fracture-driven interaction event data and the target fracture-driven interaction event data may indicate an effect an active child well has on the parent well.

In implementations, the training fracture-driven interaction event data and the target fracture-driven interaction event data may include wellbore production data.

In implementations, the wellbore production data may include production data, completion data, and pressure data.

In implementations, individual ones of the training fracture-driven interaction event probability data and the target fracture-driven interaction event probability data may include a likelihood that an active child well will affect a parent well as a function of geospatial position and time.

In implementations, the subset of the fracture-driven interaction parameters may include one of depletion time, minimum distance between wells, perforation lengths, brittleness, wellbore geometries and angles, completion size, well spacing, well length, completion size, number of stages, production drawdown time, an angle between a wellbore and a maximum horizontal stress, total proppant, and seismic anomalies.

An aspect of the present disclosure relates to a method for identifying fracture-driven interaction risk in a subsurface volume of interest. The method may be implemented in a computer system that includes a physical computer processor, a graphical user interface, and non-transitory storage medium. The method may include a number of steps. One step may include obtaining target fracture-driven interaction event data corresponding to the subsurface volume of interest. Another step may include obtaining a conditioned fracture-driven interaction model, the conditioned fracture-driven interaction model having been trained by applying training data to an initial fracture-driven interaction model. The conditioned fracture-driven interaction model may include fracture-driven interaction parameters that affect the fracture-driven interactions in the subsurface volume of interest. The training data may include (i) training fracture-driven interaction event data for the subsurface volume of interest and (ii) training fracture-driven interaction event probability data. Yet another step may include generating target fracture-driven interaction event probability data by applying the conditioned fracture-driven interaction model to the target wellbore production data.

In implementations, another step may include generating a representation of the fracture-driven interaction risk as a function of position in the subsurface volume of interest using visual effects to depict at least a portion of the fracture-driven interaction event probability data as a function of position in the subsurface volume of interest. Yet another step may include displaying the representation.

In implementations, individual ones of the target fracture-driven interaction event data may indicate an effect an active child well has on the parent well.

In implementations, the target fracture-driven interaction event data may include wellbore production data.

In implementations, the wellbore production data may include production data, completion data, and pressure data.

In implementations, individual ones of the target fracture-driven interaction event probability data may include a likelihood that an active child well will affect a parent well as a function of geospatial position and time.

In implementations, the fracture-driven interaction parameters may include one of depletion time, minimum distance between wells, perforation lengths, brittleness, wellbore geometries and angles, completion size, well spacing, well length, completion size, number of stages, production drawdown time, an angle between a wellbore and a maximum horizontal stress, total proppant, and seismic anomalies.

An aspect of the present disclosure relates to a system for identifying fracture-driven interaction risk in a subsurface volume of interest. The system may include non-transitory storage medium. The system may also include a physical computer processor configured by machine readable instructions to perform a number of steps. One step may include obtaining target fracture-driven interaction event data corresponding to the subsurface volume of interest. Another step may include obtaining a conditioned fracture-driven interaction model, the conditioned fracture-driven interaction model having been trained by applying training data to an initial fracture-driven interaction model. The conditioned fracture-driven interaction model may include fracture-driven interaction parameters that affect the fracture-driven interactions in the subsurface volume of interest. The training data may include (i) training fracture-driven interaction event data for the subsurface volume of interest and (ii) training fracture-driven interaction event probability data. Yet another step may include generating target fracture-driven interaction event probability data by applying the conditioned fracture-driven interaction model to the target wellbore production data.

In implementations, the system may further include a graphical user interface. Another step may include generating a representation of the fracture-driven interaction risk as a function of position in the subsurface volume of interest using visual effects to depict at least a portion of the fracture-driven interaction event probability data as a function of position in the subsurface volume of interest. Yet another step may include displaying the representation.

In implementations, individual ones of the target fracture-driven interaction event probability data may include a likelihood that an active child well will affect a parent well as a function of geospatial position and time.

In implementations, the fracture-driven interaction parameters may include one of depletion time, minimum distance between wells, perforation lengths, brittleness, wellbore geometries and angles, completion size, well spacing, well length, completion size, number of stages, production drawdown time, an angle between a wellbore and a maximum horizontal stress, total proppant, and seismic anomalies.

An aspect of the present disclosure relates to a non-transitory computer-readable storage medium storing instruction for identifying fracture-driven interaction risk in a subsurface volume of interest. The instructions may be configured to, when executed, perform a number of steps. One step may include obtaining target fracture-driven interaction event data corresponding to the subsurface volume of interest from a non-transitory storage medium. Another step may include obtaining a conditioned fracture-driven interaction model from the non-transitory storage medium, the conditioned fracture-driven interaction model having been trained by applying training data to an initial fracture-driven interaction model. The conditioned fracture-driven interaction model may include fracture-driven interaction parameters that affect the fracture-driven interactions in the subsurface volume of interest. The training data may include (i) training fracture-driven interaction event data for the subsurface volume of interest and (ii) training fracture-driven interaction event probability data. Yet another step may include generating target fracture-driven interaction event probability data by applying the conditioned fracture-driven interaction model to the target wellbore production data. Another step may include generating a representation of the fracture-driven interaction risk as a function of position in the subsurface volume of interest using visual effects to depict at least a portion of the fracture-driven interaction event probability data as a function of position in the subsurface volume of interest. Yet another step may include displaying the representation.

These and other features and characteristics of the present technology, as well as the methods of operation and functions of the related elements of structure and the combination of parts, will become more apparent upon consideration of the following description and the appended Claims with reference to the accompanying drawings, all of which form a part of this specification, wherein like reference numerals designate corresponding parts in the various figures. It is to be expressly understood, however, that the drawings are for the purpose of illustration and description and are not intended as a definition of the limits of the presently disclosed technology.

The technology disclosed herein, in accordance with various implementations, is described in detail with reference to the following figures. The drawings are provided for purposes of illustration and merely depict typical or example implementations of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

### BRIEF DESCRIPTION OF THE DRAWINGS

FIG. 1 shows a system configured for detecting fracture-driven interactions and identifying fracture-driven interaction risk in a subsurface volume of interest, in accordance with some implementations.

FIG. 2A is a flowchart of a method of detecting fracture-driven interactions in a subsurface volume of interest, in accordance with some implementations.

FIG. 2B is a flowchart of a method of identifying fracture-driven interaction risk in a subsurface volume of interest, in accordance with some implementations.

FIG. 3 illustrates an example graph of wellbore production data, a trend of the wellbore production data, and threshold parameters, in accordance with some implementations.

FIG. 4 illustrates an example threshold spatial region, in accordance with some implementations.

FIG. 5 illustrates an example representation of fracture-driven interaction events in a subsurface volume of interest, in accordance with some implementations.

FIG. 6 illustrates an example representation of fracture-driven interaction risk in a subsurface volume of interest, in accordance with some implementations.

FIG. 7 illustrates example computing component, in accordance with some implementations.

### DETAILED DESCRIPTION

Reference will now be made in detail to various implementations, examples of which are illustrated in the accompanying drawings. In the following detailed description, numerous details may be set forth in order to provide a thorough understanding of the present disclosure and the implementations described herein. However, implementations described herein may be practiced without such details. In other instances, some methods, procedures, components, and mechanical apparatuses may not be described in detail, so as not to unnecessarily obscure aspects of the implementations.

Unconventional wells may need to be hydraulically fractured to produce meaningful quantities of hydrocarbon from their low permeability reservoirs. When new wells are fractured near existing wells or existing wells are refractured, fracture-driven interactions may occur. Fracture-driven interactions may include unintended interference between nearby wells that may occur during fracturing. In implementations, a child well, a more recently completed well, may affect a parent well, an existing well. For example, during operation of the child well, hydraulic fracture sand and fluids may affect the baseline production of the parent well. As another example, a fracture-driven interaction may occur due to non-optimal hydraulic fracture geometry of the child well. These fracture-driven interactions can create a number of different issues, including, for example, offsetting base-line production in parent wells, ending production in parent wells, or reducing production. Thus, understanding when fracture-driven interactions are and the likelihood that fracturing or refracturing a child well may cause fracture-driven interactions can be invaluable information on the subsurface volume of interest. There are very few, if any, previous approaches to examine the effects of fracture-driven interactions, in part, because there are very limited instances where the same subsurface volume of interest is being fractured (or refractured) such that the structure of the existing subsurface volume may be affected.

The presently disclosed technology makes the automated detection of fracture-driven interactions possible from wellbore production data. For example, the presently disclosed technology may leverage wellbore production data and spatiotemporal characteristics to detect fracture-driven interactions and determine fracture-driven interaction risks on future fracturing (or re-fracturing). In implementations, a trend of the wellbore production data and threshold parameters may be used to determine fracture-driven interaction candidate data. The fracture-driven interaction candidate data may be used to identify any active child wells and corresponding potentially interactive wellbore production data to detect any fracture-driven interaction events. The presently disclosed technology can be used to identify when production from an established hydrocarbon well, one example of a parent well, is impacted from the fracture stimulation completion operations, or other fracturing operations, of a nearby child well. As an example, the presently disclosed technology may be used to reduce loss production outcome impact, identify potential hazards for a facility, and optimize well planning and development strategy design infill well opportunities. Moreover, the presently disclosed technology can be used to automatically identify fracture-driven interaction risks using fracture-driven interaction event data.

Disclosed below are methods, systems, and computer readable storage media that may detect fracture-driven interactions and identify fracture-driven interaction risks in a subsurface volume of interest. A subsurface volume of interest may include any area, region, and/or volume underneath a surface. Such a volume may include, or be bounded by, one of a water surface, a ground surface, and/or another surface.

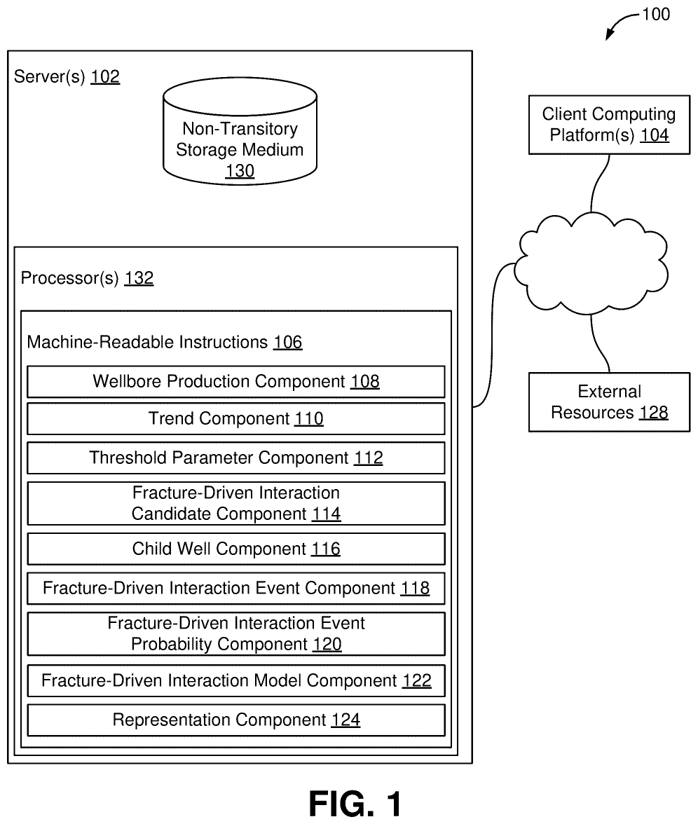

FIG. 1 illustrates a system 100 configured for detecting fracture-driven interactions in a subsurface volume of interest and identifying fracture-driven interaction risks in the subsurface volume of interest, in accordance with some implementations. In implementations, system 100 may detect fracture-driven interactions and identify fracture-driven interaction risks in the subsurface volume of interest. In some implementations, system 100 may include a server 102. Server(s) 102 may be configured to communicate with a client computing platform 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include an instruction component. The instruction components may include computer program components. The instruction components may include one of a wellbore production component 108, a trend component 110, a threshold parameter component 112, a fracture-driven interaction candidate representation component 114, a child well component 116, a fracture-driven interaction event component 118, a fracture-driven interaction event probability component 120, a fracture-driven interaction model component 122, a representation component 124, and/or other instruction components.

Wellbore production data component 108 may be configured to obtain wellbore production data in the subsurface volume of interest. This may be accomplished by a physical computer processor. The wellbore production data may include production data corresponding to production of fluid in the subsurface volume of interest as a function of geospatial position and time, completion data corresponding to extraction of fluid as a function of geospatial position and time, and pressure data corresponding to pressure of fluid in a well in the subsurface volume of interest as a function of geospatial position and time. The wellbore production data may be quantified as a function of geospatial position and time. Production data may include produced natural gas, condensate oil, and/or water volumes, pressure data, temperature data, stress data (e.g., bottom hole pressure, well head pressure, produced fluid temperature, and so on). Well production as a function of time can also utilize sensors like fiber optic cable that can record proxies for stress, temperature, and pressure. Pressure data may include bottom hole pressure, well head pressure, or any measurement derived from a sensor in contact with the production casing, rock formation, or in-situ fluid along a wellbore. Well pressure may include data that can be measured by proxy from sensors like fiber optic cable that can record proxies for stress, temperature, and pressure. Completion data may include instantaneous shut-in pressure, breakdown pressure, closure stress, or any similar interpretation of pressure graphs that record fluid conditions during the hydraulic fracture stimulation operation. It should be appreciated that this list of completion data is not exhaustive, and may also include diagnostics of the proppant, injected fluid, additives, pumping style, the total volume of proppant, fluid, and other additives in the slurry.

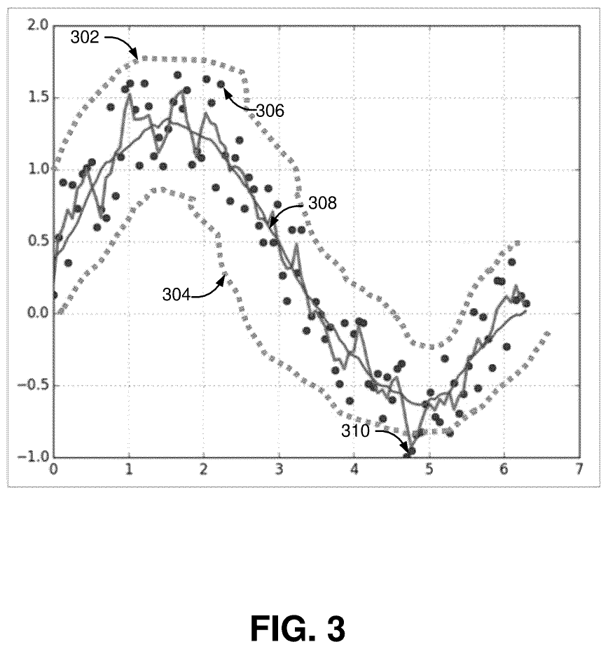

Trend component 110 may be configured to generate a trend of the wellbore production data. This may be accomplished by a physical computer processor. The trend may be generated using a filter. The filter may be applied to the wellbore production data. In some implementations, the filter may include one or more types of filters. For example, the filter may be a low-pass filter. The filter may result in a polynomial function that fits successive subsets of points, or windows, to the wellbore production data. The filter may include coefficients selected to normalize large changes in data. The selected coefficient values may also reduce distortion and suppress noise. In implementations, a smaller window size may be appropriate to improve fitting accuracy and smoothing. In some implementations, the window size may be dynamic to, for example, account for the value differences between successive points. For example, the window size may be five successive datapoints, ten successive datapoints, fifty successive datapoints, 100 successive datapoints, and so on, including any incremental values between the above-identified values. In some implementations, the filter may use convolution. In implementations, the resulting polynomial function may be the trend. For example, referring to FIG. 3, points 306 may represent wellbore production data. Line 308 may represent the trend. A trend could also be, for example, a linear regression, a non-linear regression, a curve-fit, or other type of pattern that generally moves in a particular direction for a particular length of time. The trend may include models that approximate the relationship between completion event measurements of fracture pressure and time along a wellbore during the completion procedure.

Referring back to FIG. 1, threshold parameter component 112 may be configured to generate threshold parameters. This may be accomplished by a physical computer processor. Threshold parameters may refer to boundaries set based on the wellbore production data. Threshold parameters may include, for example, a positive rolling standard deviation and a negative rolling standard deviation. A positive rolling standard deviation may be a standard deviation for a moving window above the trend. In implementations, the size of the moving window may be the same window size as the filter. In some implementations, the size of the moving window may be independent of the window size of the filter. A negative rolling standard deviation may be a standard deviation for a moving window below the trend. In some implementations, an absolute threshold based on the range of values in the wellbore production data may be used. For example, referring again to FIG. 3, dotted lines 302 and 304 may represent the positive rolling standard deviation and the negative rolling standard deviation, respectively.

Referring back to FIG. 1, fracture-driven interaction candidate data component 114 may be configured to generate fracture-driven interaction candidate data. This may be accomplished by a physical computer processor. The fracture-driven interaction candidate data may be a subset of the wellbore production data. The fracture-driven interaction candidate data may be quantified as a geospatial function of geospatial position and time. The fracture-driven interaction candidate data may be generated by using the trend and the threshold parameters. In implementations, the fracture-driven interaction candidate data may be the wellbore production data that extend beyond the boundaries of the trend and/or the threshold parameters. Referring again to FIG. 3 as an example, points 310 may represent fracture-driven interaction candidate data that are outside the boundaries of the trend and the threshold parameters represented by 302, 304, and 308, respectively

Referring back to FIG. 1, child well component 116 may be configured to identify an active child well. This may be accomplished by a physical computer processor. A child well may be a well that was fractured after an existing well. In implementations, the child well may be an existing well that is being refractured. The existing well may be referred to as a parent well, as described herein. The active child well may be a child well that is currently being operated on. The active child well may be identified based on being within a threshold spatial region around the parent well. The threshold spatial region may mean a region 0.1 miles from the parent well, 0.5 miles from the parent well, 1 mile from the parent well, 2 miles from the parent well, 5 miles from the parent well, 10 miles from the parent well, and so on, including any incremental values between the above-identified values. The active child well may be identified based on wellbore production data of the active child well corresponding to a coincident time of the fracture-driven interaction candidate data. The coincident time may be within a minute, 5 minutes, 10 minutes, 30 minutes, 1 hour, 2 hours, 5 hours, 10 hours, 12 hours, 18 hours, 24 hours, 2 days, 5 days, 7 days, and so on, including any incremental values between the above-identified values. In implementations, the active child well may be identified based on the threshold spatial region around the parent well and/or the coincident time corresponding to the fracture interaction candidate data for the parent well.

Referring back to wellbore production data component 108, wellbore production data component 108 may also be configured to identify potentially interactive wellbore production data. The potentially interactive wellbore production data may correspond to wellbore production data of the active child well during the coincident time. The potentially interactive wellbore production data may be quantified as a function of geospatial position and time. For example, the potentially interactive wellbore production data may include wellbore production data corresponding to the active child well that is within, for example, twenty-four hours of the fracture-driven interaction candidate data.

Fracture-driven interaction event component 118 may be configured to detect the fracture-driven interaction event. This may be accomplished by a physical computer processor. The fracture-driven interaction event may correspond to the potentially interactive wellbore production data or a subset of the potentially interactive wellbore production data that affect production in the parent well. The fracture-driven interaction event may be quantified as a function of geospatial position and time. In implementations, the potentially interactive wellbore production data may be compared to known anomaly characteristics to determine whether there is a fracture-driven interaction event. For example, a fracture driven interaction event may be quantified as a negative in case of a statistically significant and lower than expected hydrocarbon production in the parent well which may or may not be accompanied by higher than expected water production in the same parent well following the completion of the child well; a positive in case of statistically significant higher than expected hydrocarbon production in the parent well; or a neutral where no statistically significant production impact is detected in the parent well, but pressure measurements in the same parent well demonstrate increased pressure measurements during or after the completion of the child well. The fracture-driven interaction event may be detected based on the potentially interactive wellbore production data and/or the fracture-driven interaction candidate data. For example, production may need to be going on in the parent well during the coincident time and operations may need to be going on in the child well during the coincident time for a fracture-driven interaction event to be detected.

In implementations, fracture-driven interaction event component 118 may be configured to obtain training fracture-driven interaction event data for the subsurface volume of interest. The training fracture-driven interaction event data may include synthetically generated data that may be obtained through geophysics models and/or other models that use well data, completion data, subsurface data, pressure data, and/or production data. The training fracture-driven interaction event data may include wellbore production data corresponding to the fracture-driven interaction events and/or other data. The training fracture-driven interaction event data may be quantified as a function of geospatial position and time.

Fracture-driven interaction event probability component 120 may be configured to generate fracture-driven interaction event probability data. This may be accomplished by a physical computer processor. The fracture-driven interaction event probability data may be generated by applying the conditioned fracture-driven interaction model to the target wellbore production data. A piece of fracture-driven interaction event probability data may correspond to a likelihood that an active child well will have an effect on a parent well as a function of position and/or time. The training target fracture-driven interaction event probability data may be quantified as a function of geospatial position and time. The target fracture-driven interaction event probability data may be useful in identifying locations and times for constructing future wells (including refractured wells).

Fracture-driven interaction event probability component 120 may be configured to obtain training fracture-driven interaction event probability data. This may be accomplished by a physical computer processor. A given datapoint of the fracture-driven interaction event probability data may correspond to a likelihood that an active child well will have an effect on a parent well as a function of geospatial position and/or time, as described herein. The training fracture-driven interaction event probability data may include synthetically generated data that may be obtained through geophysics models and/or other models that use well data, completion data, subsurface data, pressure data, and/or production data. The training target fracture-driven interaction event probability data may be quantified as a function of geospatial position and time.

Fracture-driven interaction model component 122 may be configured to obtain an initial fracture-driven interaction model. The initial fracture-driven interaction model may be obtained from the non-transitory storage medium and/or another source. The initial fracture-driven interaction model may be based on machine learning techniques to map at least one variable to at least another variable. For example, the initial fracture-driven interaction model may receive fracture-driven interaction event data and/or other data as input and output fracture-driven interaction event probability data. The initial fracture-driven interaction model may be “untrained” or “unconditioned,” indicating it may not estimate an output based on the input as accurately as a “trained” or “conditioned” model.

In some implementations, an initial fracture-driven interaction model may be trained to generate a conditioned fracture-driven interaction model. The initial fracture-driven interaction model may be trained using training data. The training data may include training fracture-driven interaction event data, training fracture-driven interaction event probability data, and/or other data, as is described in greater detail herein. The training data may be derived from seismic data, well data, pressure data, completion data, production data, and/or other data. Seismic data may include fault type, fault angle, orientation, heave, vertical throw, horizontal throw, stratigraphic throw, structural attribute data including curvature data, fault property data, horizon curvature data, tectonic data including basement fault data and region stress data, and/or other seismic data. The seismic data may be collected from multiple seismic data sites/surveys (i.e., on a pad or regional scale) and correspond to different geophysical collection methods (i.e., 2D seismic, 3D seismic, multicomponent 3D seismic, time-lapse (4D) seismic, microseismic, VSP, and the like). In some implementations, seismic data may be augmented to include well data. Well data may include wellbore data, fracture data, petrophysical data, wireline logs, mud logs, completion design, well spacing, wellbore tortuosity, production data, breakdown pressure data, and/or other data. Pressure data may include bottom hole pressure, well head pressure, or any measurement derived from a sensor in contact with the production casing, rock formation, or in-situ fluid along a wellbore. Well pressure may include data that can be measured by proxy from sensors like fiber optic cable that can record proxies for stress, temperature, and pressure. Completion data may include instantaneous shut-in pressure, breakdown pressure, closure stress, or any similar interpretation of pressure graphs that record fluid conditions during the hydraulic fracture stimulation operation. It should be appreciated that this list of completion data is not exhaustive, and may also include diagnostics of the proppant, injected fluid, additives, pumping style, the total volume of proppant, fluid, and other additives in the slurry. Production data may include produced natural gas, condensate oil, and/or water volumes, pressure data, temperature data, stress data (e.g., bottom hole pressure, well head pressure, produced fluid temperature, and so on). Well production as a function of time can also utilize sensors like fiber optic cable that can record proxies for stress, temperature, and pressure.

The initial fracture-driven interaction model may include one or more components of a random forest, a deep neural network (e.g., a convolutional neural network, a generative adversarial network, and so on), a regression, a support vector machine, a k-means system, a k-nearest neighbor system, a gradient boosting system, a naive Bayes classifier, and/or other machine learning techniques. It should be appreciated that other fracture-driven interaction models may include, for example, convolutional neural networks, reinforcement learning, transfer learning, and/or other machine learning techniques. In one example, the fracture-driven interaction model may be a supervised machine learning model. In one example, the fracture-driven interaction model may be an unsupervised machine learning model.

As an example of a machine learning technique, random forest machine learning may be useful because it may have a low risk of overfitting, may allow extreme randomization, and may be very iterative. Random forest may be a modification of bootstrap aggregation that builds on a large collection of de-correlated regression trees and then averages them. Bootstrap aggregation may average many noisy but unbiased models to reduce prediction variance. Regression trees may be appropriate for bootstrap aggregation, because they can capture complex interaction structure. The random forest machine learning may use many boot strap sets and many regression trees to generate many predictions. The predictions may be averaged together to provide a conditioned fracture-driven interaction model.

Referring back to fracture-driven interaction model component 122, training the initial fracture-driven interaction model may include applying the initial fracture-driven interaction model to the training fracture-driven interaction event data and/or training fracture-driven interaction event probability data to generate a first iteration of fracture-driven interaction event probability data. The initial fracture-driven interaction model may be adjusted to more accurately estimate the fracture-driven interaction event probability data based on differences between the first iteration of fracture-driven interaction event probability data and the training fracture-driven interaction event probability data that correspond to the training data. This is repeated numerous times until the initial fracture-driven interaction model is “trained,” i.e., it is able to output fracture-driven interaction event probability data that are consistently within a threshold of the training fracture-driven interaction event probability data. In some implementations, the threshold may depend on the speed of the fracture-driven interaction model, resources used by the fracture-driven interaction model, and/or other optimization metrics. This threshold may be based on an average of values, a maximum number of values, and/or other parameters. Other metrics may be applied to determine that the fracture-driven interaction model is “conditioned” or “trained.” Consistency may be measured by the consecutive number of times the fracture-driven interaction model is able to output the fracture-driven interaction event probability data within the threshold. Consistency may be 10 consecutive times, 50 consecutive times, 100 consecutive times, 1,000 consecutive times, 10,000 consecutive times, and so on, including any incremental values between the above-identified values.

The conditioned fracture-driven interaction model may be able to predict fracture-driven interaction event risk by recognizing patterns in the training data. In some implementations, the conditioned fracture-driven interaction model may have generated a linear or non-linear relationship between the input data and the fracture-driven interaction event probability data. In implementations, fracture-driven interaction event probability data may include fracture-driven interaction parameters. The fracture-driven interaction parameters may affect the fracture-driven interactions in the subsurface volume of interest. The fracture-driven interaction parameters may include, for example, depletion time, minimum distance between wells, perforation lengths, brittleness, wellbore geometries and angles, completion size, well spacing, well length, completion size, number of stages, production drawdown time, an angle between a wellbore and a maximum horizontal stress, total proppant, seismic anomalies (e.g., faults, collapse features, discontinuities, offsets, layer curvature, and so on), and/or other parameters relating to well design and planning (e.g., well development, well engineering, and so on), and reservoir conditions (e.g., mineralogy, structure, stress orientation, and so on). In implementations, different types of fracture-driven interaction event data may be weighted differently (e.g., depletion time data may be weighted differently than total proppant data, and each of them may be weighted differently than perforation lengths). In implementations, weights of the fracture-driven interaction parameters may be modified during the training of the initial fracture-driven interaction model to more accurately estimate the fracture-driven interaction event probability data. In some implementations, a subset of the fracture-driven interaction parameters may be identified on having a greater effect on the fracture-driven interactions in the subsurface volume of interest than other parameters. In implementations, the three fracture-driven interaction parameters with the greatest effect, the five fracture-driven interaction parameters with the greatest effect, the ten fracture-driven interaction parameters with the greatest effect may be selected, the fifteen fracture-driven interaction parameters with the greatest effect, and so on, including any incremental values between the above-identified values.

The fracture-driven interaction event probability data in the subsurface region of interest may be predicted, or generated, based on applying the conditioned fracture-driven interaction model to fracture-driven interaction event data.

In implementations, fracture-driven interaction model component 122 may be configured to obtain a conditioned fracture-driven interaction model. The conditioned fracture-driven interaction model may be obtained from the non-transitory storage medium and/or another source. As discussed herein, the conditioned fracture-driven interaction model may be trained using training data on an initial fracture-driven interaction model. The conditioned fracture-driven interaction model may have been trained, as described herein, to predict fracture-driven interaction event risk.

In implementations, fracture-driven interaction model component 122 may be configured to generate a conditioned fracture-driven interaction model by training an initial fracture-driven interaction model, as discussed above.

Representation component 124 may be configured to generate a representation of the fracture-driven interaction event as a function of position and/or time in the subsurface volume of interest. The representation may be generated using visual effects to depict at least a portion of the fracture-driven interaction event. This may be accomplished by a physical computer processor. In some implementations, a visual effect may include a visual transformation of the representation. A visual transformation may include a visual change in how the representation is presented or displayed. In some implementations, a visual transformation may include one of a visual zoom, a visual filter, a visual rotation, and/or a visual overlay (e.g., text and/or graphics overlay). The visual effect may include using a temperature map, or other color coding, to indicate which positions in the subsurface volume of interest have higher or lower values.

Representation component 124 may be configured to generate a representation of the fracture-driven interaction risk as a function of position and/or time in the subsurface volume of interest. The representation may be generated using visual effects as described herein.

In some implementations, representation component 124 may be configured to display representations. The representations may be displayed on a graphical user interface and/or other displays.

In some implementations, server(s) 102, client computing platform(s) 104, and/or external resources 128 may be operatively linked via an electronic communication link. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 128 may be operatively linked via some other communication media.

A given client computing platform 104 may include a processor configured to execute computer program components. The computer program components may be configured to enable an expert or user associated with the given client computing platform 104 to interface with system 100 and/or external resources 128, and/or provide other functionality attributed herein to client computing platform(s) 104. By way of non-limiting example, the given client computing platform 104 may include one of a desktop computer, a laptop computer, a handheld computer, a tablet computing platform, a NetBook, a Smartphone, and/or other computing platforms.

External resources 128 may include sources of information outside of system 100, external entities participating with system 100, and/or other resources. In some implementations, some or all of the functionality attributed herein to external resources 128 may be provided by resources included in system 100.

Server(s) 102 may include non-transitory storage medium 130, a processors 134, and/or another component. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Non-transitory storage medium 130 may comprise electronic storage and/or non-transitory storage media that electronically stores information. Non-transitory storage medium 130 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Non-transitory storage medium 130 may include one of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Non-transitory storage medium 130 may include one or more virtual storage resources (e.g., cloud storage, a virtual private network, and/or other virtual storage resources). Non-transitory storage medium 130 may store software algorithms, information determined by processor(s) 132, information received from server(s) 102, information received from client computing platform(s) 104, and/or other information that enables server(s) 102 to function as described herein.

Processor(s) 132 may be configured to provide information processing capabilities in server(s) 102. As such, processor(s) 132 may include one of a physical computer processor, a digital processor, an analog processor, a digital circuit designed to process information, an analog circuit designed to process information, a state machine, and/or other mechanisms for electronically processing information. Although processor(s) 132 is shown in FIG. 1 as a single entity, this is for illustrative purposes. In some implementations, processor(s) 132 may include a plurality of processing units. These processing units may be physically located within the same device, or processor(s) 132 may represent processing functionality of a plurality of devices operating in coordination. Processor(s) 132 may be configured to execute components 108, 110, 112, 114, 116, 118, 120, 122, 124, and/or other components. Processor(s) 132 may be configured to execute components 108, 110, 112, 114, 116, 118, 120, 122, 124, and/or other components by software; hardware; firmware; some combination of software, hardware, and/or firmware; and/or other mechanisms for configuring processing capabilities on processor(s) 132. As used herein, the term “component” may refer to any component or set of components that perform the functionality attributed to the component. This may include a physical processor during execution of processor readable instructions, the processor readable instructions, circuitry, hardware, storage media, or any other components.

It should be appreciated that although components 108, 110, 112, 114, 116, 118, 120, 122, and/or 124 are illustrated in FIG. 1 as being implemented within a single processing unit, in implementations in which processor(s) 132 includes multiple specialized processing units, one of components 108, 110, 112, 114, 116, 118, 120, 122, and/or 124 may be implemented remotely from the other components. The description of the functionality provided by the different components 108, 110, 112, 114, 116, 118, 120, 122, and/or 124 described below is for illustrative purposes, and is not intended to be limiting, as any of components 108, 110, 112, 114, 116, 118, 120, 122, and/or 124 may provide more or less functionality than is described. For example, one of components 108, 110, 112, 114, 116, 118, 120, 122, and/or 124 may be eliminated, and some or all of its functionality may be provided by other ones of components 108, 110, 112, 114, 116, 118, 120, 122, and/or 124. As an example, processor(s) 132 may be configured to execute an additional component that may perform some or all of the functionality attributed below to one of components 108, 110, 112, 114, 116, 118, 120, 122, and/or 124.

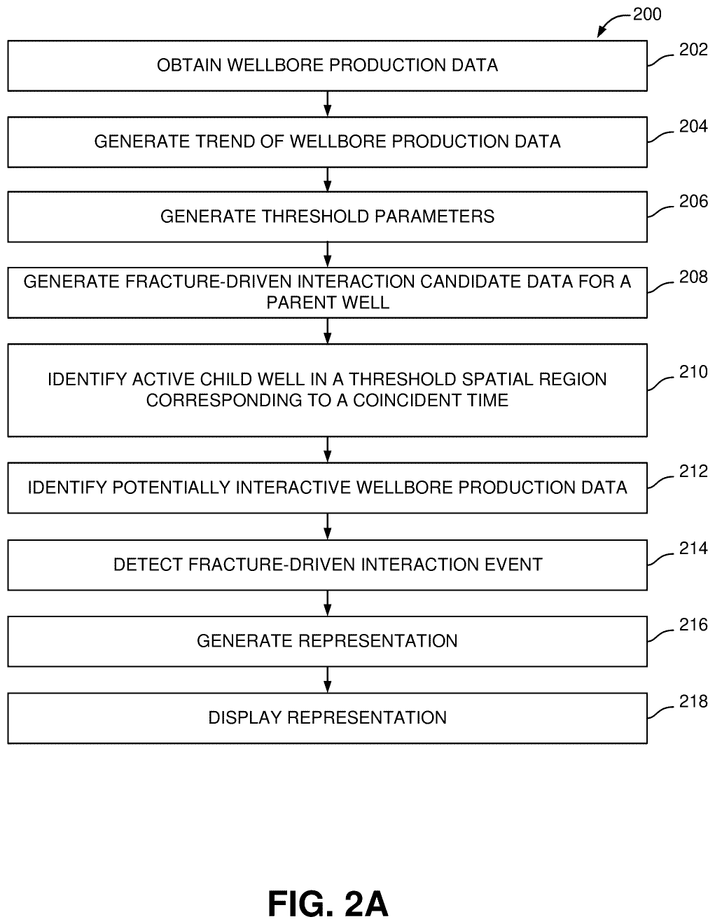

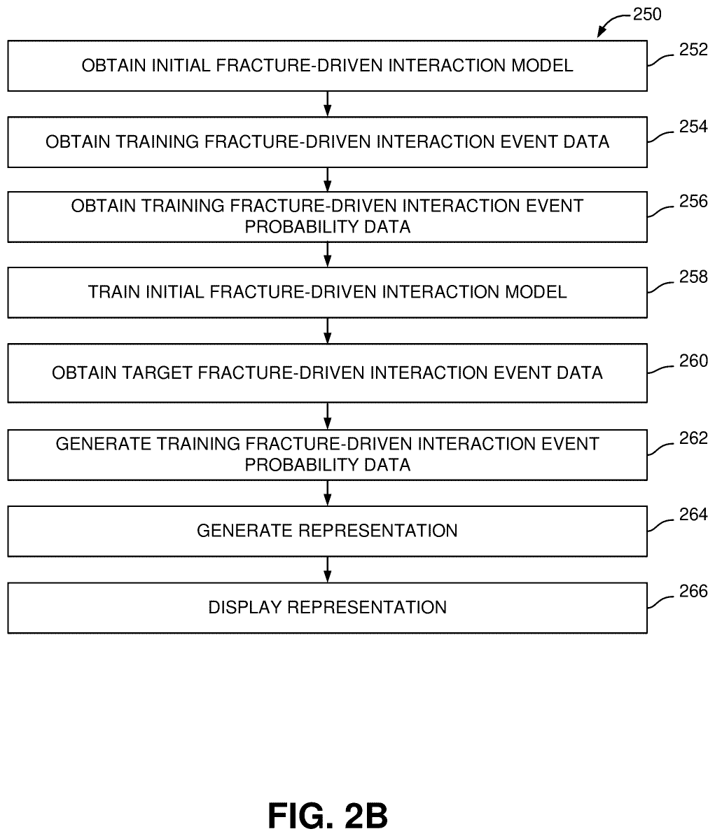

FIG. 2A illustrates a method 200 for detecting fracture-driven interactions in a subsurface volume of interest, in accordance with some implementations. The operations of method 200 presented below is intended to be illustrative. In some implementations, method 200 may be accomplished with an additional operation not described, and/or without one of the operations discussed. Additionally, the order in which the operations of method 200 is illustrated in FIG. 2 and described below is not intended to be limiting.

In some implementations, method 200 may be implemented in a processing device (e.g., a digital processor, a physical computer processor, an analog processor, a digital circuit designed to process information, an analog circuit designed to process information, a state machine, and/or other mechanisms for electronically processing information). The processing device may include a device executing some or all of the operations of method 200 in response to instructions stored electronically on a non-transitory storage medium. The processing device may include a device configured through hardware, firmware, and/or software to be specifically designed for execution of one of the operations of method 200.

An operation 202 may include obtaining wellbore production data corresponding to the subsurface volume of interest. As described herein, the wellbore production data may include production data, completion data, and pressure data. Operation 202 may be performed by a physical computer processor configured by machine-readable instructions including a component that is the same as or similar to wellbore production component 108, in accordance with some implementations.

An operation 204 may include generating a trend of the wellbore production data. The trend may be generated by applying a filter to the wellbore production data. The trend may be derived by convolving subsets of the wellbore production data. The subsets may be defined by a window size, or the number of individual wellbore production datapoints in a subset, as described herein. Operation 204 may be performed by a physical computer processor configured by machine-readable instructions including a component that is the same as or similar to trend component 110, in accordance with some implementations.

An operation 206 may include generating threshold parameters. Generating threshold parameters may be based on the wellbore production data. The threshold parameters may be used to set boundaries on the wellbore production data. As an example, the threshold parameters may be derived from rolling standard deviations of the wellbore production data, as described herein. Operation 206 may be performed by a physical computer processor configured by machine-readable instructions including a component that is the same as or similar to threshold parameter 112, in accordance with some implementations.

An operation 208 may include generating fracture-driven interaction candidate data. Generating the fracture-driven interaction candidate data for a parent well may include applying the trend and the threshold parameters to the subsurface data. The fracture-driven interaction candidate data may be a subset of the wellbore production data that exceed the ranges generated by the threshold parameters. Operation 208 may be performed by a physical computer processor configured by machine-readable instructions including a component that is the same as or similar to fracture-driven interaction candidate component 114, in accordance with some implementations.

An operation 210 may include identifying an active child well. Identifying the active child well may include determining the threshold spatial region around the parent well and the coincident time of the fracture-driven interaction candidate data for the parent well. The threshold spatial region may cover up to a ten mile radius, though it should be appreciated that other threshold spatial regions are envisioned, as described herein. The coincident time may cover up to a twenty-four hour period, though it should be appreciated that other coincident times are envisioned, as described herein. The active child well may be a child well that is currently being operated on. A child well that is currently being operated on may include refracturing existing wells. Operation 210 may be performed by a physical computer processor configured by machine-readable instructions including a component that is the same as or similar to child well component 116, in accordance with some implementations.

An operation 212 may include identifying potentially interactive wellbore production data. Identifying potentially interactive wellbore production data may correspond to the active child well during the coincident time. Operation 212 may be performed by a physical computer processor configured by machine-readable instructions including a component that is the same as or similar to wellbore production component 108, in accordance with some implementations.

An operation 214 may include detecting the fracture-driven interaction event. Detecting the fracture-driven interaction event may be based on the potentially interactive wellbore production data and the fracture-driven interaction candidate data. The fracture-driven interaction event may indicate an effect the active child well has on the parent well. Operation 214 may be performed by a physical computer processor configured by machine-readable instructions including a component that is the same as or similar to fracture-driven interaction event component 118, in accordance with some implementations.

An operation 216 may include generating a representation of the fracture-driven interaction events as a function of position and/or time in the subsurface volume of interest. The representation may be generated by using visual effects, as described herein. Operation 216 may be performed by a physical computer processor configured by machine-readable instructions including a component that is the same as or similar to representation component 124, in accordance with some implementations.

An operation 218 may include displaying the representation. Operation 216 may be performed by a physical computer processor configured by machine-readable instructions including a component that is the same as or similar to representation component 124, in accordance with some implementations.

FIG. 2B illustrates a method 250 for identifying fracture-driven interaction risk in a subsurface volume of interest, in accordance with some implementations. The operations of method 250 presented below is intended to be illustrative. In some implementations, method 250 may be accomplished with an additional operation not described, and/or without one of the operations discussed. Additionally, the order in which the operations of method 250 is illustrated in FIG. 2B and described below is not intended to be limiting.

In some implementations, method 250 may be implemented in a processing device (e.g., a digital processor, a physical computer processor, an analog processor, a digital circuit designed to process information, an analog circuit designed to process information, a state machine, and/or other mechanisms for electronically processing information). The processing device may include a device executing some or all of the operations of method 250 in response to instructions stored electronically on a non-transitory storage medium. The processing device may include a device configured through hardware, firmware, and/or software to be specifically designed for execution of one of the operations of method 250.

An operation 252 may include obtaining an initial fracture-driven interaction model. The initial fracture-driven interaction model may be “untrained” or “unconditioned,” indicating it may not estimate an output based on the input as accurately as a “trained” or “conditioned” model. In some implementations, an initial fracture-driven interaction model may be trained into a trained fracture-driven interaction model. The initial fracture-driven interaction model may be trained using training data. The initial fracture-driven interaction model may include a machine learning model. The machine learning model may include a random forest, a deep neural network (e.g., a convolutional neural network, a generative adversarial network, and so on), a regression, a support vector machine, a k-means system, a k-nearest neighbor system, a gradient boosting system, a naive Bayes classifier, and/or other machine learning techniques. Operation 252 may be performed by a physical computer processor configured by machine-readable instructions including a component that is the same as or similar to fracture-driven interaction model component 122, in accordance with some implementations.

An operation 254 may include obtaining training fracture-driven interaction event data. The training fracture-driven interaction event data may include wellbore production data corresponding to the fracture-driven interaction events and/or other data, as described herein. Operation 254 may be performed by a physical computer processor configured by machine-readable instructions including a component that is the same as or similar to fracture-driven interaction event component 118, in accordance with some implementations.

An operation 256 may include obtaining training fracture-driven interaction event probability data. The training fracture-driven interaction event probability data may correspond to likelihoods that active child wells will affect a parent well as a function of position and/or time, as described herein. Operation 256 may be performed by a physical computer processor configured by machine-readable instructions including a component that is the same as or similar to fracture-driven interaction event probability component 120, in accordance with some implementations.

An operation 258 may include training the initial fracture-driven interaction model using, at least, the training fracture-driven interaction event data and training fracture-driven interaction event probability data. The trained fracture-driven interaction model may be able to predict fracture-driven interaction risk, as described herein. Operation 258 may be performed by a physical computer processor configured by machine-readable instructions including a component that is the same as or similar to fracture-driven interaction model component 122, in accordance with some implementations.

An operation 260 may include obtaining target fracture-driven interaction event data. The target fracture-driven interaction event data may include wellbore production data corresponding to the fracture-driven interaction events, the fracture-driven interaction events, and/or other data, as described herein. Operation 260 may be performed by a physical computer processor configured by machine-readable instructions including a component that is the same as or similar to fracture-driven interaction event component 118, in accordance with some implementations.

An operation 262 may include generating target fracture-driven interaction event probability data. The target fracture-driven interaction event probability data may correspond to likelihoods that active child wells will affect a parent well as a function of position and/or time, as described herein. Operation 262 may be performed by a physical computer processor configured by machine-readable instructions including a component that is the same as or similar to fracture-driven interaction event probability component 120, in accordance with some implementations.

An operation 264 may include generating a representation of the fracture-driven interaction risk as a function of position in the subsurface region of interest. The representation may be generated using visual effects to display at least some of the target fracture-driven interaction event probability data as a function of position in the subsurface region of interest. Operation 264 may be performed by a physical computer processor configured by machine-readable instructions including a component that is the same as or similar to representation component 124, in accordance with some implementations.

An operation 266 may include displaying the representation. Operation 266 may be performed by a physical computer processor configured by machine-readable instructions including a component that is the same as or similar to representation component 124, in accordance with some implementations.

FIG. 3 illustrates an example graph of wellbore production data, a trend of the wellbore production data, and threshold parameters, in accordance with some implementations. As described herein, points 306 may represent wellbore production data. Line 308 may represent the trend of the wellbore production data. Dotted lines 302 and 304 may represent the threshold parameters (e.g., positive rolling standard deviation and the negative rolling standard deviation, respectively). Points 310 may represent examples of fracture-driven interaction candidate data that are outside the boundaries of the trend and the threshold parameters represented by 302, 304, and 308, respectively.

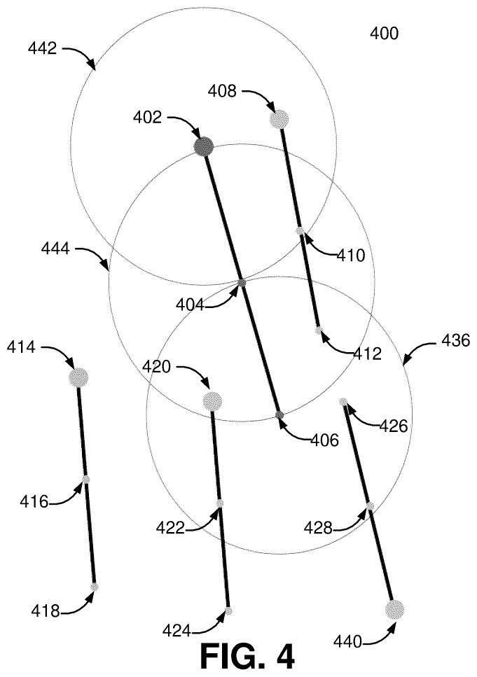

FIG. 4 illustrates a threshold spatial region, in accordance with some implementations. Points 402, 404, and 406 correspond to a child well. Points 408, 410, and 412 correspond to a parent well. Points 414, 416, and 418 correspond to a well outside the threshold spatial regions. Points 420, 422, and 424 correspond to a parent well. Points 426, 428, and 440 correspond to a parent well. Points 402, 408, 414, 420, and 440 represent surface holes of a given well. Points 404, 410, 416, 422, and 428 represent midpoints between a surface hole for a given well and a corresponding bottom of the given well. Points 406, 412, 418, 424, and 440 represent bottoms of wells. Circle 442 represents a circular spatial region around point 402. In this example, the threshold spatial region is a distance that is 5500 ft from a given point on the child well (represented by points 402, 404, and 406). In implementations, the threshold spatial region may be a volume (e.g., covering a spherical region, a cylindrical region, etc.). A parent well may be a well that has any part of the well within the threshold spatial region of any part of the child well. For example, while point 440 is outside the threshold spatial regions of any part of the child well, points 426 and 428 are within the threshold spatial regions of the child well, and the well represented by points 426, 428, and 440 is identified as a parent well.

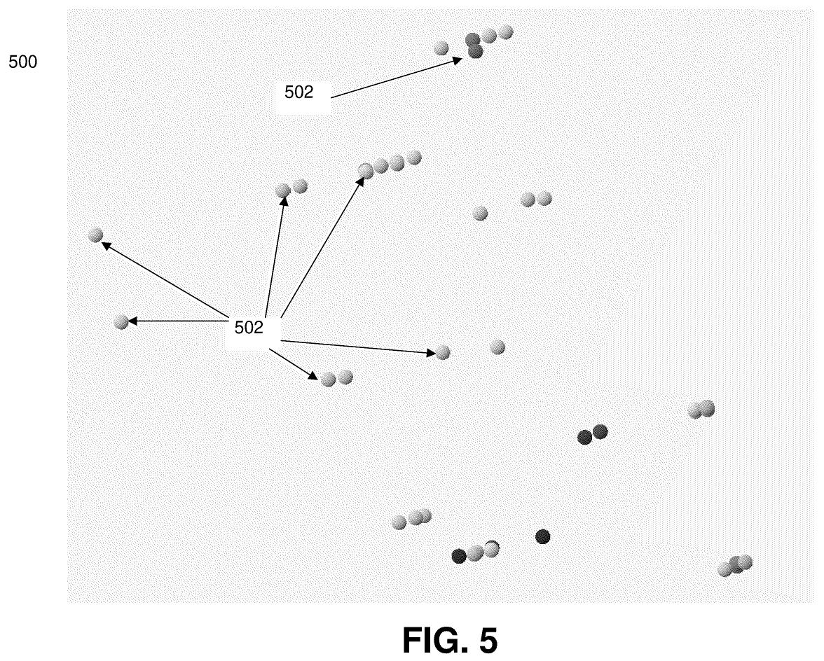

FIG. 5 illustrates an example representation of fracture-driven interaction events in a subsurface volume of interest, in accordance with some implementations. 500 represents a subsurface volume of interest. 502 represents fracture-driven interaction events detected in the subsurface volume of interest. The fracture-driven interaction events may be detected as described herein. This example representation may be invaluable to understanding existing fracture-driven interactions in the subsurface volume of interest.

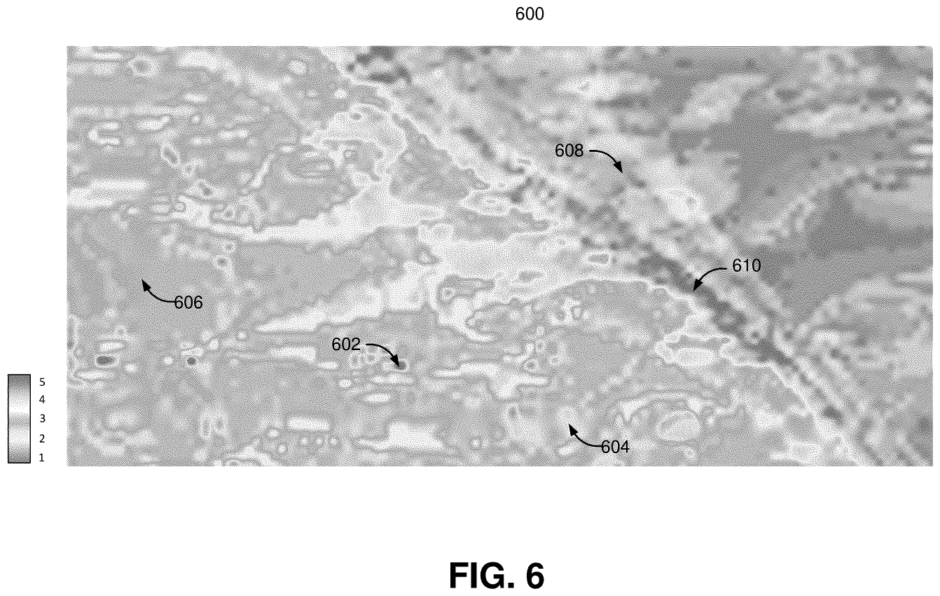

FIG. 6 illustrates an example representation of fracture-driven interaction risk in a subsurface volume of interest, in accordance with some implementations. 600 represents a subsurface volume of interest. Regions 602, 604, and 606 represent regions where a fracture-driven interaction event probability is identified for the subsurface volume of interest. Regions with colors next to the “5” on the bar on the left of the figure represent the highest probability of a fracture-driven interaction event. For example, region 610 may be a higher probability region (e.g., around “5” on the bar on the left). Region 608 may be a medium-high probability region (e.g., around “4” on the bar on the left). Region 606 may be a medium probability region (e.g., around “3” on the bar on the left). Region 604 may be a medium probability region (e.g., around “2” on the bar on the left). Region 602 may be a medium probability region (e.g., around “1” on the bar on the left). This example representation may be invaluable to exploration and design of future wells in the subsurface volume of interest.

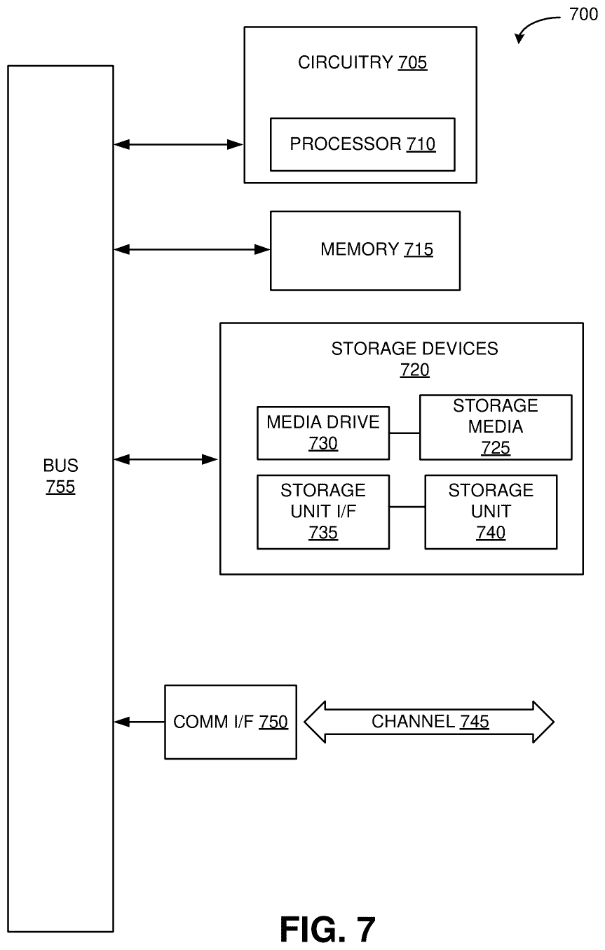

FIG. 7 illustrates example computing component 700, which may in some instances include a processor/controller resident on a computer system (e.g., server system 102). Computing component 700 may be used to implement various features and/or functionality of implementations of the systems, devices, and methods disclosed herein. With regard to the above-described implementations set forth herein in the context of systems, devices, and methods described with reference to FIGS. 1 through 6, including implementations involving server(s) 102, it may be appreciated additional variations and details regarding the functionality of these implementations that may be carried out by computing component 700. In this connection, it will also be appreciated upon studying the present disclosure that features and aspects of the various implementations (e.g., systems) described herein may be implemented with respect to other implementations (e.g., methods) described herein without departing from the spirit of the disclosure.

As used herein, the term component may describe a given unit of functionality that may be performed in accordance with some implementations of the present application. As used herein, a component may be implemented utilizing any form of hardware, software, or a combination thereof. For example, a processor, controller, ASIC, PLA, PAL, CPLD, FPGA, logical component, software routine, or other mechanism may be implemented to make up a component. In implementation, the various components described herein may be implemented as discrete components or the functions and features described may be shared in part or in total among components. In other words, it should be appreciated that after reading this description, the various features and functionality described herein may be implemented in any given application and may be implemented in separate or shared components in various combinations and permutations. Even though various features or elements of functionality may be individually described or claimed as separate components, it will be appreciated that upon studying the present disclosure that these features and functionality may be shared among a common software and hardware element, and such description shall not require or imply that separate hardware or software components are used to implement such features or functionality.

Where components of the application are implemented in whole or in part using software, in implementations, these software elements may be implemented to operate with a computing or processing component capable of carrying out the functionality described with respect thereto. One such example computing component is shown in FIG. 7. Various implementations are described in terms of example computing component 700. After reading this description, it will be appreciated how to implement example configurations described herein using other computing components or architectures.

Referring now to FIG. 7, computing component 700 may represent, for example, computing or processing capabilities found within mainframes, supercomputers, workstations or servers; desktop, laptop, notebook, or tablet computers; hand-held computing devices (tablets, PDA's, smartphones, cell phones, palmtops, etc.); or the like, depending on the application and/or environment for which computing component 700 is specifically purposed.

Computing component 700 may include, for example, a processor, controller, control component, or other processing device, such as a processor 710, and such as may be included in circuitry 705. Processor 710 may be implemented using a special-purpose processing engine such as, for example, a microprocessor, controller, or other control logic. In the illustrated example, processor 710 is connected to bus 755 by way of circuitry 705, although any communication medium may be used to facilitate interaction with other components of computing component 700 or to communicate externally.

Computing component 700 may also include a memory component, simply referred to herein as main memory 715. For example, random access memory (RAM) or other dynamic memory may be used for storing information and instructions to be executed by processor 710 or circuitry 705. Main memory 715 may also be used for storing temporary variables or other intermediate information during execution of instructions to be executed by processor 710 or circuitry 705. Computing component 700 may likewise include a read only memory (ROM) or other static storage device coupled to bus 755 for storing static information and instructions for processor 710 or circuitry 705.

Computing component 700 may also include various forms of information storage devices 720, which may include, for example, media drive 730 and storage unit interface 735. Media drive 730 may include a drive or other mechanism to support fixed or removable storage media 725. For example, a hard disk drive, a floppy disk drive, a magnetic tape drive, an optical disk drive, a CD or DVD drive (R or RW), or other removable or fixed media drive may be provided. Accordingly, removable storage media 725 may include, for example, a hard disk, a floppy disk, magnetic tape, cartridge, optical disk, a CD or DVD, or other fixed or removable medium that is read by, written to, or accessed by media drive 730. As these examples illustrate, removable storage media 725 may include a computer usable storage medium having stored therein computer software or data.

In alternative implementations, information storage devices 720 may include other similar instrumentalities for allowing computer programs or other instructions or data to be loaded into computing component 700. Such instrumentalities may include, for example, fixed or removable storage unit 740 and storage unit interface 735. Examples of such removable storage units 740 and storage unit interfaces 735 may include a program cartridge and cartridge interface, a removable memory (for example, a flash memory or other removable memory component) and memory slot, a PCMCIA slot and card, and other fixed or removable storage units 740 and storage unit interfaces 735 that allow software and data to be transferred from removable storage unit 740 to computing component 700.

Computing component 700 may also include a communications interface 750. Communications interface 750 may be used to allow software and data to be transferred between computing component 700 and external devices. Examples of communications interface 750 include a modem or softmodem, a network interface (such as an Ethernet, network interface card, WiMedia, IEEE 702.XX, or other interface), a communications port (such as for example, a USB port, IR port, RS232 port Bluetooth® interface, or other port), or other communications interface. Software and data transferred via communications interface 750 may typically be carried on signals, which may be electronic, electromagnetic (which includes optical) or other signals capable of being exchanged by a given communications interface 750. These signals may be provided to/from communications interface 750 via channel 745. Channel 745 may carry signals and may be implemented using a wired or wireless communication medium. Some non-limiting examples of channel 745 include a phone line, a cellular or other radio link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 715, storage unit interface 735, removable storage media 725, and channel 745. These and other various forms of computer program media or computer usable media may be involved in carrying a sequence of instructions to a processing device for execution. Such instructions embodied on the medium, are generally referred to as “computer program code” or a “computer program product” (which may be grouped in the form of computer programs or other groupings). When executed, such instructions may enable the computing component 700 or a processor to perform features or functions of the present application as discussed herein.

Various implementations have been described with reference to specific example features thereof. It will, however, be evident that various modifications and changes may be made thereto without departing from the broader spirit and scope of the various implementations as set forth in the appended claims. The specification and figures are, accordingly, to be regarded in an illustrative rather than a restrictive sense.

Although described above in terms of various example implementations and implementations, it should be understood that the various features, aspects, and functionality described in one of the individual implementations are not limited in their applicability to the particular implementation with which they are described, but instead may be applied, alone or in various combinations, to other implementations of the present application, whether or not such implementations are described and whether or not such features are presented as being a part of a described implementation. Thus, the breadth and scope of the present application should not be limited by any of the above-described example implementations.

Terms and phrases used in the present application, and variations thereof, unless otherwise expressly stated, should be construed as open ended as opposed to limiting. As examples of the foregoing: the term “including” should be read as meaning “including, without limitation,” or the like; the term “example” is used to provide illustrative instances of the item in discussion, not an exhaustive or limiting list thereof; the terms “a” or “an” should be read as meaning “at least one,” or the like; and adjectives such as “standard,” “known,” and terms of similar meaning should not be construed as limiting the item described to a given time period or to an item available as of a given time, but instead should be read to encompass standard technologies that may be available or known now or at any time in the future. Likewise, where this document refers to technologies that would be appreciated to one of ordinary skill in the art, such technologies encompass that which would be appreciated by the skilled artisan now or at any time in the future.

The presence of broadening words and phrases such as “at least,” “but not limited to,” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, may be combined in a single package or separately maintained and may further be distributed in multiple groupings or packages or across multiple locations.

Additionally, the various implementations set forth herein are described in terms of example block diagrams, flow charts, and other illustrations. As will be appreciated after reading this document, the illustrated implementations and their various alternatives may be implemented without confinement to the illustrated examples. For example, block diagrams and their accompanying description should not be construed as mandating a particular architecture or configuration.

What is claimed is:

1. A system for detecting fracture-driven interactions in a subsurface volume of interest, the system comprising:
non-transitory storage medium; and
a physical computer processor configured by machine readable instructions to:
obtain wellbore production data corresponding to the subsurface volume of interest from the non-transitory storage medium;
generate, with the physical computer processor, a trend of the wellbore production data by applying a filter to the wellbore production data;
generate, with the physical computer processor, threshold parameters based on the wellbore production data, wherein the threshold parameters are used to set boundaries on the wellbore production data;
generate, with the physical computer processor, fracture-driven interaction candidate data for a parent well by applying the trend and the threshold parameters to the subsurface data, wherein the fracture-driven interaction candidate data is a subset of the wellbore production data that exceed the ranges generated by the threshold parameters;
identify, with the physical computer processor, an active child well in a threshold spatial region around the parent well corresponding to a coincident time of the fracture-driven interaction candidate data for the parent well;
identify, with the physical computer processor, potentially interactive wellbore production data corresponding to the active child well during the coincident time; and
detect, with the physical computer processor, the fracture-driven interaction event based on the potentially interactive wellbore production data and the fracture-driven interaction candidate data.

2. The system of claim 1, wherein the physical computer processor is further configured by machine readable instructions to:
generate, on the graphical user interface, a representation of the fracture-driven interactions as a function of position in the subsurface volume of interest using visual effects to depict at least a portion of the fracture-driven interaction event as a function of position in the subsurface volume of interest; and
display, via the graphical user interface, the representation.

3. The system of claim 1, wherein the wellbore production data comprises production data, completion data, and pressure data.

4. The system of claim 1, wherein the trend is derived by convolving subsets of the wellbore production data.

5. The system of claim 1, wherein the threshold parameters are derived from rolling standard deviations of the wellbore production data.

6. The system of claim 1, wherein the threshold spatial region covers a 10 mile radius, and wherein the coincident time covers a twenty-four hour period.

7. The system of claim 1, wherein the fracture-driven interaction event indicates an effect the active child well has on the parent well.

8. A non-transitory computer-readable storage medium having instructions embodied thereon, the instructions being executable by a physical computer processor to perform a method for detecting fracture-driven interactions in a subsurface volume of interest, the method comprising:
obtaining wellbore production data corresponding to the subsurface volume of interest from non-transitory storage medium;
generating, with a physical computer processor, a trend of the wellbore production data by applying a filter to the wellbore production data;
generating, with the physical computer processor, threshold parameters based on the wellbore production data, wherein the threshold parameters are used to set boundaries on the wellbore production data;
generating, with the physical computer processor, fracture-driven interaction candidate data for a parent well by applying the trend and the threshold parameters to the subsurface data, wherein the fracture-driven interaction candidate data is a subset of the wellbore production data that exceed the ranges generated by the threshold parameters;
identifying, with the physical computer processor, an active child well in a threshold spatial region around the parent well corresponding to a coincident time of the fracture-driven interaction candidate data for the parent well;
identifying, with the physical computer processor, potentially interactive wellbore production data corresponding to the active child well during the coincident time; and
detecting, with the physical computer processor, the fracture-driven interaction event based on the potentially interactive wellbore production data and the fracture-driven interaction candidate data.

9. The non-transitory computer-readable storage medium of claim 8, wherein the method further comprises:
generating, on a graphical user interface, a representation of the fracture-driven interactions as a function of position in the subsurface volume of interest using visual effects to depict at least a portion of the fracture-driven interaction event as a function of position in the subsurface volume of interest; and
displaying, via the graphical user interface, the representation.

10. The non-transitory computer-readable storage medium of claim 8, wherein the wellbore production data comprises production data, completion data, and pressure data.

11. The non-transitory computer-readable storage medium of claim 8, wherein the fracture-driven interaction event indicates an effect the active child well has on the parent well.

12. A method for identifying fracture-driven interaction risk in a subsurface volume of interest, the method being implemented in a computer system that comprises a physical computer processor and non-transitory storage medium, the method comprising:
obtaining an initial fracture-driven interaction model from a non-transitory storage medium, wherein the initial fracture-driven interaction model comprises fracture-driven interaction parameters that affect the fracture-driven interactions in the subsurface volume of interest;
obtaining, from the non-transitory storage medium, training fracture-driven interaction event data;
obtaining, from the non-transitory storage medium, training fracture-driven interaction event probability data;
training, with the physical computer processor, the initial fracture-driven interaction model to generate a conditioned fracture-driven interaction model predicting fracture-driven interaction risk based on the training fracture-driven interaction event data and the fracture-driven interaction event probability data, wherein the conditioned fracture-driven interaction model comprises a subset of the fracture-driven interaction parameters that have a greater effect on the fracture-driven interactions in the subsurface volume of interest; and
storing the conditioned fracture-driven interaction model.

13. The method of claim 12, further comprising:
obtaining target fracture-driven interaction event data corresponding to the subsurface volume of interest from the non-transient electronic storage;
generating, with the physical computer processor, target fracture-driven interaction event probability data by applying the conditioned fracture-driven interaction model to the target wellbore production data.

14. The method of claim 12, further comprising:
generating, on a graphical user interface, a representation of the fracture-driven interaction risk as a function of position in the subsurface volume of interest using visual effects to depict at least a portion of the fracture-driven interaction event probabilities as a function of position in the subsurface volume of interest; and
displaying, via the graphical user interface, the representation.

15. The method of claim 12, wherein individual ones of the training fracture-driven interaction event data and the target fracture-driven interaction event data indicate an effect an active child well has on the parent well.

16. The method of claim 12, wherein the training fracture-driven interaction event data and the target fracture-driven interaction event data comprise wellbore production data.

17. A system for identifying fracture-driven interaction risk in a subsurface volume of interest, the system comprising:
non-transitory storage medium;
a physical computer processor configured by machine readable instructions to:
obtain target fracture-driven interaction event data corresponding to the subsurface volume of interest from the non-transitory storage medium;
obtain a conditioned fracture-driven interaction model from the non-transitory storage medium, the conditioned fracture-driven interaction model having been trained by applying training data to an initial fracture-driven interaction model, wherein the conditioned fracture-driven interaction model comprises fracture-driven interaction parameters that affect the fracture-driven interactions in the subsurface volume of interest, and wherein the training data includes (i) training fracture-driven interaction event data for the subsurface volume of interest and (ii) training fracture-driven interaction event probability data; and
generate, with the physical computer processor, target fracture-driven interaction event probability data by applying the conditioned fracture-driven interaction model to the target wellbore production data.

18. The system of claim 17, further comprising a graphical user interface, and wherein the physical computer processor is further configured by machine readable instructions to:
generate on the graphical user interface, a representation of the fracture-driven interaction risk as a function of position in the subsurface volume of interest using visual effects to depict at least a portion of the fracture-driven interaction event probability data as a function of position in the subsurface volume of interest; and
display, via the graphical user interface, the representation.

19. The system of claim 17, wherein individual ones of the target fracture-driven interaction event probability data comprise a likelihood that an active child well will affect a parent well as a function of geospatial position and time.

20. The system of claim 17, wherein the fracture-driven interaction parameters comprise one of depletion time, minimum distance between wells, perforation lengths, brittleness, wellbore geometries and angles, completion size, well spacing, well length, completion size, number of stages, production drawdown time, an angle between a wellbore and a maximum horizontal stress, total proppant, and seismic anomalies.
